(19) United States
(12) Patent Application Publication
(10) Pub. No.: US 2020/0231178 A1
(43) Pub. Date: Jul. 23, 2020

(54) VEHICLE CONTROL SYSTEM, VEHICLE CONTROL METHOD, AND PROGRAM

(71) Applicant: HONDA MOTOR CO., LTD., Minato-ku, Tokyo (JP)

(72) Inventors: Hisashi Murayama, Wako-shi (JP); Sachiko Nakazawa, Wako-shi (JP)

(21) Appl. No.: 16/634,180

(22) PCT Filed: Aug. 7, 2017
(86) PCT No.: PCT/JP2017/028595

§ 371 Date: Jan. 27, 2020

(51) Int. Cl. B60W 60/00; B60W 50/14; B60W 30/09

(52) U.S. Cl. CPC B60W 60/0013; B60W 60/0011; B60W 30/09; B60W 60/0016; B60W 60/0025; B60W 50/14

(57) ABSTRACT

A vehicle control system includes an interface configured to receive an input of information from an occupant of a vehicle, an inquirer configured to, when the vehicle selects an action related to a behavior change of the vehicle in response to an event occurring while the vehicle is traveling, control the interface and to inquire of the occupant of the vehicle as to whether to execute the action, an information processor configured to acquire information indicating affirmation or denial by the occupant of the inquiry, which has been input to the interface, and a controller configured to execute control of on-board equipment in the vehicle, which associated with the action, in accordance with the information indicating affirmation or denial of the occupant acquired by the information processor.

### TECHNICAL FIELD

The present invention relates to a vehicle control system, a vehicle control method, and a program.

### BACKGROUND ART

Conventionally, a vehicle which notifies an occupant of a planned route before a behavior of a vehicle changes when a lane change event occurs during automated driving has been disclosed (for example, refer to Patent Literature 1).

### CITATION LIST

### Patent Literature

### [Patent Literature 1]

U.S. Pat. No. 8,738,213

### SUMMARY OF INVENTION

### Technical Problem

However, a lane change event has been executed in the vehicle described above regardless of an intention of the occupant in some cases. As described above, in conventional vehicle control, the intention of the occupant may not be sufficiently reflected.

The present invention is made in view of such circumstances, and an object thereof is to provide a vehicle control assist device, a vehicle control method, and a program which can perform control of on-board equipment in which the intention of the occupant is reflected.

### Solution to Problem

(1) A vehicle control system includes an interface configured to receive an input of information from an occupant of a vehicle, an inquirer configured to, when the vehicle selects an action related to a behavior change of the vehicle in response to an event occurring while the vehicle is traveling, control the interface and to inquire of the occupant of the vehicle as to whether to execute the action, an information processor configured to acquire information indicating affirmation or denial by the occupant of the inquiry, which has been input to the interface, and a controller configured to execute control of on-board equipment in the vehicle, which associated with the action, in accordance with the information indicating affirmation or denial of the occupant, which is acquired by the information processor.

(2) In (1), the controller executes control of the on-board equipment associated with the action without executing an inquiry to the occupant using the inquirer when a first type of event occurs in the event, and executes control of the on-board equipment associated with the action in accordance with the information indicating affirmation or denial of the occupant, which is acquired by the information processor when a second type of event other than the first type of event occurs.

(3) In (1) or (2), the event occurs on the basis of a situation outside the vehicle.

(4) In (1) to (3), the action includes at least one of controlling steering of the vehicle and controlling acceleration or deceleration.

(5) In (1) to (4), the action is an operation of causing another vehicle to interrupt in front of the vehicle.

(6) In (1) to (5), the event includes receiving a request signal for interruption from another vehicle, and the action when the request signal is received is an operation of causing the another vehicle to interrupt in front of the vehicle.

(7) In (5) or (6), when the information processor acquires information indicating agreement with the interruption, the controller controls the vehicle such that the vehicle allows the another vehicle to interrupt and, when the information processor acquires information indicating non-agreement with the interruption, the controller controls the vehicle such that the vehicle does not allow the another vehicle to interrupt.

(8) In (1) to (7), a storage configured to store a history of the affirmation or denial of the occupant associated with the action is further included, and the inquirer makes the inquiry to the occupant on the basis of the history stored in the storage such that an answer with a larger frequency between the affirmation and denial is an answer indicating agreement.

(9) In (1) to (8), a learner configured to perform learning by linking geographic factors or environmental factors to the affirmation or denial of the occupant is further included, and the inquirer makes an inquiry to an occupant such that the occupant is more likely to give an answer of agreement on the basis of the geographic factors or the environmental factors when the inquiry is made to the occupant.

(10) A vehicle control method includes, by a computer, inquiring of, when a vehicle selects an action related to a behavior change of the vehicle in response to an event occurring while the vehicle travels, an occupant of the vehicle as to whether to execute the action by controlling an interface that receives an input of information from the occupant of the vehicle, acquiring information indicating affirmation or denial by the occupant of the inquiry input to the interface, and executing control of on-board equipment of the vehicle, which associated with the action, in accordance with the acquired information indicating affirmation or denial of the occupant.

(11) A program which causes a computer to inquire of, when a vehicle selects an action related to a behavior change of the vehicle in response to an event occurring while the vehicle travels, an occupant of the vehicle as to whether to execute the action by controlling an interface that receives an input of information from the occupant of the vehicle, to acquire information indicating affirmation or denial by the occupant of the inquiry input to the interface, and to execute control of on-board equipment of the vehicle, which associated with the action, in accordance with the acquired information indicating affirmation or denial of the occupant.

### Advantageous Effects of Invention

According to (1) to (7), (10), and (11), it is possible to perform control of on-board equipment in which the intention of the occupant is reflected. As a result, reliability of the occupant with respect to control of a vehicle can be improved.

According to (8) and (9), the reliability of the occupant with respect to the control of a vehicle can be further improved by making an inquiry such that the occupant is likely to give an answer of agreement. In addition, convenience for a user can be improved.

### BRIEF DESCRIPTION OF DRAWINGS

FIG. 1 is a configuration diagram of a vehicle system 1 including an automated driving controller 100.

FIG. 2 is a diagram which shows how a relative position and a posture of a host vehicle M with respect to a travel lane L1 are recognized by the host vehicle position recognizer 122.

FIG. 3 is a diagram which shows how a target trajectory is generated on the basis of a recommended lane.

FIG. 4 is a diagram which shows an example of a scene in which the host vehicle M receives a request signal.

FIG. 5 is a diagram which shows an example of an image IM displayed on a display 32 and a voice VO output from a speaker 34.

FIG. 6 is a diagram which shows an example of a scene in which the host vehicle M has permitted a lane change.

FIG. 7 is a diagram which shows an example of a scene in which the host vehicle M transmits information indicating that a lane change is permitted to another vehicle m and the another vehicle m changes a lane to a lane L2.

FIG. 8 is a diagram which shows an example of a scene in which the another vehicle m has transmitted information indicating gratitude to the host vehicle M.

FIG. 9 is a diagram which shows an example of a voice VO1 output from the speaker 34 and an image IM2 displayed on the display 32.

FIG. 10 is a flowchart which shows an example of a flow of processing executed by the information processor 124.

FIG. 11 is a diagram which shows an example of an image displayed on the display 32 in a modified example 1.

FIG. 12 is a diagram which shows an example of affirmation or denial information 162.

FIG. 13 is a configuration diagram of a vehicle system 1 including an automated driving controller 100A of a second embodiment.

FIG. 14 is a diagram which shows an example of target information 164.

FIG. 15 is a diagram which shows an example of hardware configurations of the automated driving controller 100 and 100A of the embodiments.

### DESCRIPTION OF EMBODIMENTS

Hereinafter, embodiments of a vehicle control system, a vehicle control method, and a program of the present invention will be described with reference to the drawings.

### First Embodiment

[Overall Configuration]

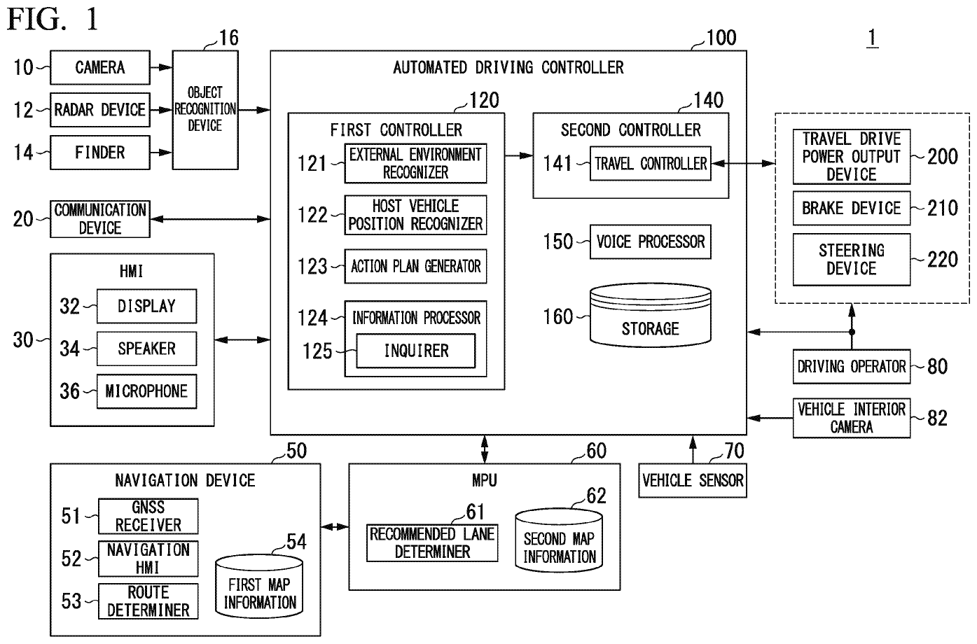

FIG. 1 is a configuration diagram of a vehicle system 1 including an automated driving controller 100. A vehicle on which the vehicle system 1 is mounted is, for example, a two-wheel, three-wheel, or four-wheel vehicle, and the driving source is an internal combustion engine such as a diesel engine or a gasoline engine, an electric motor, and a combination of these. The electric motor operates using electric power generated by a generator connected to the internal combustion engine, or discharge electric power of a secondary battery or a fuel cell.

The vehicle system 1 includes, for example, a camera 10, a radar device 12, a finder 14, an object recognition device 16, a communication device 20, a human machine interface (HMI) 30, an electronic toll collection system (ETC) on-board device 40, a navigation device 50, a micro-processor (MPU) 60, a vehicle sensor 70, a driving operator 80, a vehicle interior camera 90, an automated driving controller 100, a travel drive power output device 200, a brake device 210, and a steering device 220. These devices and equipment are connected to each other by a multiple communication line such as a controller area network (CAN) communication line, a serial communication line, a wireless communication network, and the like. Note that the configuration shown in FIG. 1 is merely an example, and a part of the configuration may be omitted, or another configuration may be further added. The HMI 30 is an example of an “interface.”

The camera 10 is, for example, a digital camera using a solid-state image device such as a charge-coupled device (CCD) or a complementary metal-oxide semiconductor (CMOS). One or more of cameras 10 are attached to any place of a vehicle (hereinafter, referred to as a host vehicle M) on which the vehicle system 1 is mounted. When the front is imaged, the camera 10 is attached to an upper part of a front windshield, a rear surface of the rear-view mirror, or the like. The camera 10 images, for example, a periphery of the host vehicle M periodically and repeatedly. The camera 10 may be a stereo camera.

The radar device 12 emits radio waves such as millimeter waves to the periphery of the host vehicle M, and detects at least a position (a distance and an orientation) of an object by detecting the radio waves (reflected waves) reflected against the object. One or a plurality of radar devices 12 are attached to arbitrary places of the host vehicle M. The radar device 12 may detect the position and a speed of the object using a frequency modulated continuous wave (FM-CW) method.

The finder 14 is a light detection and ranging or laser imaging detection and ranging (LIDAR) that measures scattered light with respect to the irradiation light and detects a distance to a target. One or a plurality of finders 14 are attached to arbitrary places of the host vehicle M.

The object recognition device 16 performs sensor fusion processing on a result of detection performed by a part or all of the camera 10, the radar device 12, and the finder 14, and recognizes a position, a type, a speed, and the like of an object. The object recognition device 16 outputs a result of the recognition to the automated driving controller 100.

The communication device 20 communicates with another vehicle present in the periphery of the host vehicle M using, for example, a cellular network, a Wi-Fi network, a Bluetooth (registered trademark), a dedicated short range communication (DSRC), or the like, or communicates with various types of server devices via a wireless base station.

The HMI 30 presents various types of information to the occupant of the host vehicle M and receives an input operation performed by the occupant. The HMI 30 includes a display 32, a speaker 34, and a microphone 36. The display 32 may have a configuration in which a display device such as a liquid crystal display (LCD) or an organic electro luminescence (EL) display and a touch pad are combined. The display 32 is, for example, positioned under the front windshield, and is installed on a dashboard provided in front of a driver's seat and a passenger seat.

In addition, the display 32 may be installed in front of the driver's seat and may function as an instrument panel (facia) that displays instruments such as a speedometer and a tachometer. In addition, the HMI 30 includes various types of display device, buzzers, touch panels, switches, key boards, and the like. In addition, the display 32 may be, for example, a head up display (HUD) that projects an image onto a part of the front windshield in front of the driver's seat such that eyes of an occupant sitting on the driver's seat are caused to visually recognize a virtual image.

The speaker 34 outputs a voice in accordance with an instruction from the information processor 124. The microphone 36 outputs a voice input by the occupant to a voice processor 150.

The navigation device 50 includes, for example, a global navigation satellite system (GNSS) receiver 51, a navigation HMI 52, and a route determiner 53, and holds first map information 54 in a storage device such as a hard disk drive (HDD) or a flash memory. The GNSS receiver identifies a position of the host vehicle M on the basis of a signal received from a GNSS satellite. The position of the host vehicle M may be identified or supplemented by an inertial navigation system (INS) using an output of the vehicle sensor 70. The navigation HMI 52 includes a display device, a speaker, a touch panel, a key, and the like. The navigation HMI 52 may be partly or wholly shared with the HMI 30 described above. The route determiner 53 determines, for example, a route to a destination input by the occupant using the navigation HMI 52 from the position of the host vehicle M identified by the GNSS receiver 51 (or an input arbitrary position) with reference to the first map information 54. The first map information 54 is, for example, information in which a road shape is expressed by a link indicating a road and nodes connected by the link. The first map information 54 may include road curvature, point of interest (POI) information, and the like. The route determined by the route determiner 53 is output to the MPU 60. In addition, the navigation device 50 may perform route guidance using the navigation HMI 52 on the basis of the route determined by the route determiner 53. Note that the navigation device 50 may be realized by, for example, a function of a terminal device such as a smart-phone or a tablet terminal carried by a user. In addition, the navigation device 50 may transmit a current position and a destination to a navigation server through the communication device 20, and may acquire a route returned from the navigation server.

The MPU 60 functions as, for example, a recommended lane determiner 61 and holds second map information 62 in a storage device such as an HDD or a flash memory. The recommended lane determiner 61 divides a route provided from the navigation device 50 into a plurality of blocks (for example, divides every 100 [m] in a vehicle traveling direction), and determines a target lane for each block with reference to the second map information 62. The recommended lane determiner 61 performs a determination on which number lane from the left to travel. The recommended lane determiner 61 determines a recommended lane such that the host vehicle M can travel a reasonable route for proceeding to a branch destination when a branch point, a joining point, and the like are present in the route.

The second map information 62 is map information with higher accuracy than the first map information 54. The second map information 62 includes, for example, information on a center of a lane or information on a boundary of the lane. In addition, the second map information 62 may include road information, traffic regulation information, address information (address and postal code), facility information, telephone number information, and the like. The road information includes information indicating a type of a road such as an express way, a toll road, a national road, and a prefectural road, and information on the number of lanes of a road, a width of each lane, a gradient of a road, a position (three dimensional coordinates includes longitude, latitude, and height) of a road, lane curve curvature, positions of lane junction and a branch point, signs provided on a road, and the like. The second map information 62 may be updated at any time by accessing other vehicles using the communication device 20.

Moreover, the second map information 62 stores information indicating a state of a road near an entrance toll gate or an exit toll gate. The information indicating the state of a road is, for example, information including information on a lane, information on a width of the road, information on a mark, and the like.

The vehicle sensor 70 includes a vehicle speed sensor that detects a speed of the host vehicle M, an acceleration sensor that detects acceleration, a yaw rate sensor that detects an angular speed around a vertical axis, an orientation sensor that detects a direction of the host vehicle M, and the like.

The driving operator 80 includes, for example, an accelerator pedal, a brake pedal, a shift lever, a steered wheel, and other operators. A sensor that detects an amount of operation or a presence or absence of an operation is attached to the driving operator 80. A result of this detection is output to one or both of the automated driving controller 100, the travel drive power output device 200, or the brake device 210 and the steering device 220.

The vehicle interior camera 90 captures an image of an upper body centered on a face of an occupant sitting at a driver's seat. The captured image by the vehicle interior camera 90 is output to the automated driving controller 100.

The automated driving controller 100 includes, for example, a first controller 120, a second controller 140, a voice processor 150, and a storage 160. The first controller 120, the second controller 140, and the voice processor 150 are realized by a processor such as a central processor (CPU) executing a program (software), respectively. In addition, a part or all of the functional units may be realized by hardware such as a large-scale integration (LSI), an application-specific integrated circuit (ASIC), or a field-programmable gate array (FPGA), and may also be realized by cooperation of software and hardware. The storage 160 is realized by, for example, a non-volatile storage device such as a read-only memory (ROM), an electrically erasable and programmable read-only memory (EEPROM), or a hard disk drive (HDD), and a volatile storage device such as a random-access memory (RAM) or a register. The first controller 120 is an example of a “controller.”

The first controller 120 includes, for example, an external environment recognizer 121, a host vehicle position recognizer 122, an action plan generator 123, and an information processor 124.

The external environment recognizer 121 recognizes a position and a state such as a speed or an acceleration of a surrounding vehicle on the basis of information input from the camera 10, the radar device 12, and the finder 14 through the object recognition device 16. The position of a surrounding vehicle may be represented by a representative point such as a center of gravity or a corner of the surrounding vehicle, or may be represented by an area expressed by an outline of the surrounding vehicle. The “state” of a surrounding vehicle may include an acceleration, jerk, or an “action state” (for example, whether it performs or intends to perform a lane change) of the surrounding vehicle. In addition, the external environment recognizer 121 may recognize positions of guardrails, utility poles, parked vehicles, pedestrians, and other objects in addition to the surrounding vehicle.

The host vehicle position recognizer 122 recognizes, for example, a lane (travel lane) in which the host vehicle M is traveling, and a relative position and a posture of the host vehicle M with respect to the travel lane. The host vehicle position recognizer 122 recognizes, for example, the travel lane by comparing a pattern of a road marking line obtained from the second map information 62 (for example, an array of solid lines and broken 1 lines) and a pattern of a road marking line in the periphery of the host vehicle M recognized from an image captured by the camera 10. In this recognition, the position of the host vehicle M acquired from the navigation device 50 or a result of processing by INS may be added.

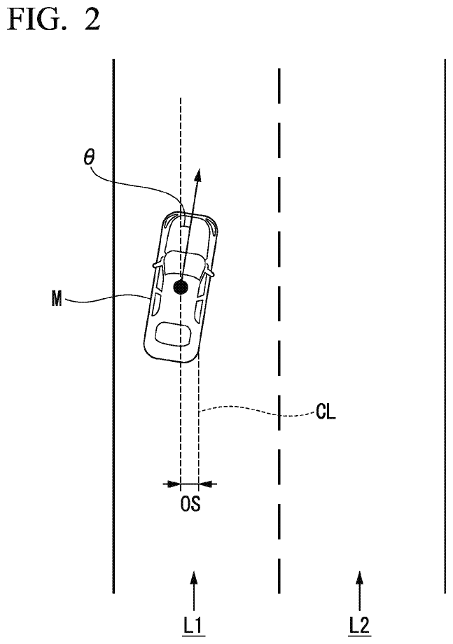

Then, the host vehicle position recognizer 122 recognizes, for example, a position and a posture of the host vehicle M with respect to a travel lane. FIG. 2 is a diagram which shows how a relative position and the posture of the host vehicle M with respect to a travel lane L1 are recognized by the host vehicle position recognizer 122. The host vehicle position recognizer 122 recognizes, for example, a deviation OS from a travel lane center CL of a reference point (for example, a center of gravity) of the host vehicle M, and an angle θ formed with respect to a line linked to the travel lane center CL of the host vehicle M in a traveling direction as the relative position and the posture of the host vehicle M with respect to the travel lane L1. Note that, instead of this, the host vehicle position recognizer 122 may recognize a position or the like of the reference point of the host vehicle M with respect to any side end of the host lane L1 as the relative position of the host vehicle M with respect to the travel lane. The relative position of the host vehicle M recognized by the host vehicle position recognizer 122 is provided to the recommended lane determiner 61 and the action plan generator 123.

The action plan generator 123 determines an event to be sequentially executed in automated driving to travel a recommended lane determined by the recommended lane determiner 61 and to cope with a surrounding situation of the host vehicle M. The event includes, for example, a constant speed travel event that travels the same travel lane at a constant speed, a following-up event that follows up a preceding vehicle, a lane change event, a joining event, a branch event, an emergency stop event, a handover event for ending automated driving and switching it to manual driving, and the like. In addition, during execution of these events, an action for avoidance may be planned on the basis of the surrounding situation (a presence of surrounding vehicles or pedestrians, lane narrowing or the like due to road construction) of the host vehicle M.

The action plan generator 123 generates a target trajectory that the host vehicle M will travel in the future. The target trajectory includes, for example, a speed element. For example, the target trajectory sets a plurality of future reference times for each predetermined sampling time (for example, about 0 comma [sec]), and is generated as a set of target points (trajectory points) that should be reached at these reference times. For this reason, when an interval between trajectory points is wide, this indicates that a section between these trajectory points is traveled at a high speed.

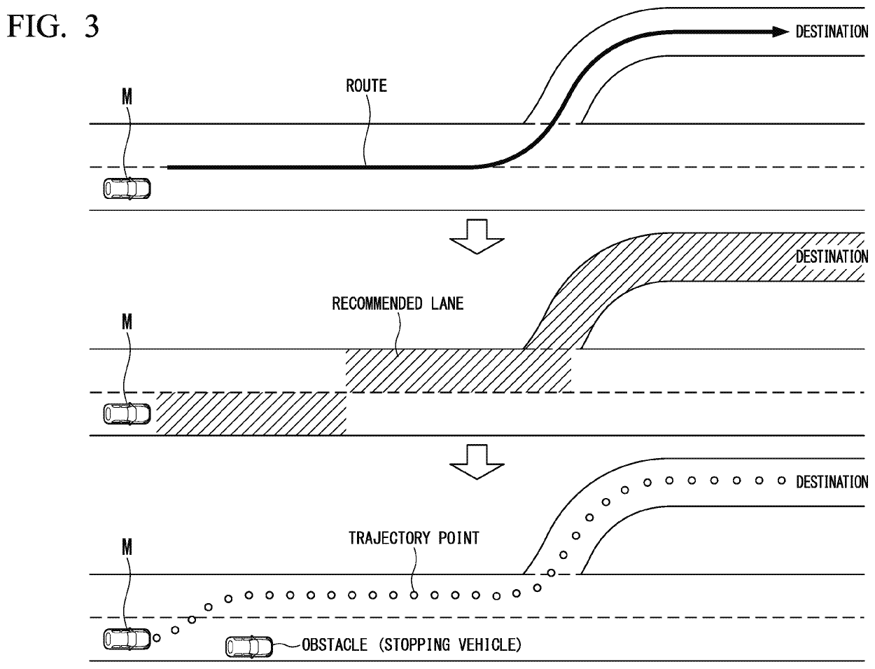

FIG. 3 is a diagram which shows how a target trajectory is generated on the basis of a recommended lane. As shown in FIG. 3, a recommended lane is set such that it is convenient to travel along the route to a destination. The action plan generator 123 starts a lane change event, a branching event, a joining event, and the like if the vehicle approaches a predetermined distance before a switching point of the recommended lane (may be determined in accordance with the type of an event). When it is necessary to avoid obstacles during the execution of each event, an avoidance trajectory is generated as shown.

The action plan generator 123 generates, for example, a plurality of candidates for a target trajectory, and selects an optimal target trajectory at that time on the basis of viewpoints of safety and efficiency.

The action plan generator 123 executes control of on-board equipment associated with an action (the details will be described below) in accordance with information indicating a permission of an occupant, which is acquired by the information processor 124.

The information processor 124 includes an inquirer 125. When the inquirer 125 selects an action related to a behavior change of the host vehicle M with respect to an event occurring while the host vehicle M is traveling, the inquirer 125 inquires of the occupant of the host vehicle M as to whether to execute control associated with the action by controlling the HMI 30. The information processor 124 acquires information indicating the affirmation or denial by the occupant of the inquiry input to the HMI 30.

The event is, for example, an event that occurs on the basis of a situation outside the host vehicle M. The event occurring on the basis of the situation outside the host vehicle M is, for example, an event determined by the action plan generator 123 on the basis of a result of the recognition performed by the external environment recognizer 121 or an event that receives a request signal to be described below. The action is, for example, to cause a predetermined behavior expected in advance to occur in the host vehicle M by controlling steering of the host vehicle M or controlling acceleration or deceleration thereof. More specifically, the action when a request signal is received is, for example, to allow another vehicle to interrupt in front of the host vehicle M.

In addition, the action related to the behavior change of the vehicle includes an automatic lane change or overtaking in automated driving, inter-vehicle communication with another vehicle during travel, a display of outside the vehicle, and digital signage. The display of outside the vehicle and the digital signage include the host vehicle stopping for pedestrians who intend to cross and displaying a pedestrian crossing on a road surface to encourage pedestrians to cross, and the like. In addition, the action related to the behavior change of the vehicle may include a predetermined notification to another vehicle present in the vicinity of the host vehicle M and an object (people), other notifications, and the like.

The second controller 140 includes a travel controller 141. The travel controller 141 controls the travel drive power output device 200, the brake device 210, and the steering device 220 such that the host vehicle M passes along the target trajectory generated by the action plan generator 123 at a scheduled time.

The voice processor 150 causes the speaker 34 to output a voice inquiring an affirmation or denial for joining of another vehicle or a lane change in accordance with an instruction from the inquirer 125. In addition, the voice processor 150 acquires a response to the inquiry of an affirmation or denial described above input to the microphone 36, analyzes the acquired information, and converts it into text information. The voice processor 150 compares, for example, the converted text information and the information stored in the storage 160, and determines whether the response to the inquiry indicates agreement or non-agreement. The information stored in the storage 160 is, for example, phrases indicating a plurality of agreements and phrases indicating a plurality of non-agreements associated with the inquiry.

For example, when the response to the inquiry matches a phrase indicating agreement, the voice processor 150 determines that the occupant agrees to the inquiry, and, when the response to the inquiry does not match a phrase indicating non-agreement, it determines that the occupant disagrees to the inquiry. Note that matching is not limited to a complete match, but also includes a partial match.

The travel drive power output device 200 outputs a travel drive power (torque) for traveling of a vehicle to drive wheels. The travel drive power output device 200 includes, for example, a combination of an internal combustion engine, an electric motor, a transmission, and the like, and an ECU that controls them. The ECU controls the above constituents in accordance with information input from the travel controller 141 or information input from the driving operator 80.

The brake device 210 includes, for example, a brake caliper, a cylinder that transmits a hydraulic pressure to the brake caliper, an electric motor that causes the cylinder to generate a hydraulic pressure, and a brake ECU. The brake ECU controls the electric motor in accordance with the information input from the travel controller 141 or the information input from the driving operator 80, and helps brake torque associated with a braking operation to be output to each wheel. The brake device 210 may include a mechanism that transmits a hydraulic pressure generated by an operation of a brake pedal included in the driving operator 80 to the cylinder through a master cylinder as a backup. Note that the brake device 210 is not limited to the configuration described above, and may be an electronically controlled hydraulic brake device that controls an actuator in accordance with the information input from the travel controller 141, and transmits the hydraulic pressure of the master cylinder to the cylinder.

The steering device 220 includes, for example, a steering ECU and an electric motor. The electric motor changes a direction of the steered wheels by, for example, applying force to a rack and pinion mechanism. The steering ECU drives the electric motor in accordance with the information input from the travel controller 141 or the information input from the driving operator 80, and changes the direction of the steered wheels.

[Processing when Interruption Request Signal is Received]

After an interruption request signal (hereinafter, a request signal) is received from another vehicle, when the occupant of the host vehicle M agrees to the interruption, the another vehicle is allowed to interrupt in front of the host vehicle M.

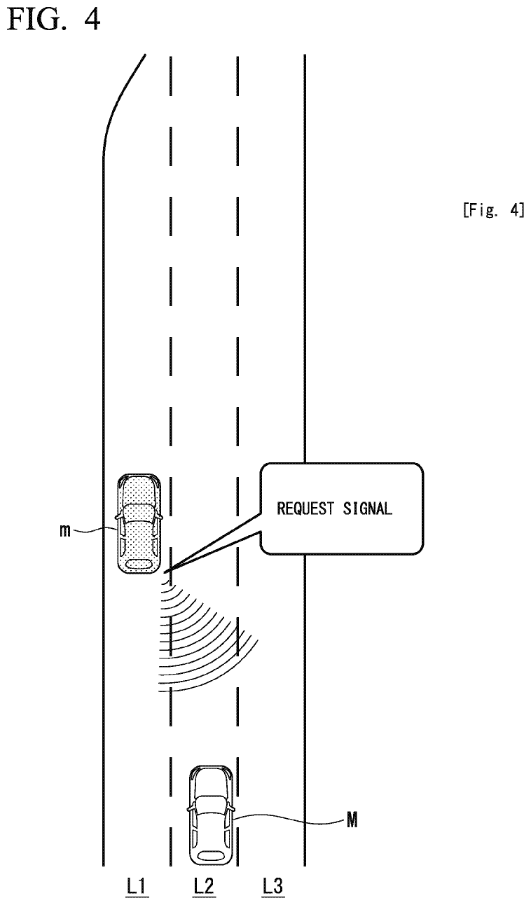

FIG. 4 is a diagram which shows an example of a scene in which the host vehicle M receives a request signal. In the example shown in FIG. 4, the host vehicle M travels a lane L2 on a road having lanes L1 to L3. In addition, another vehicle m travels in front of the host vehicle M in the lane L2. The lane L2 is a joining lane and a lane in front of the another vehicle m disappears.

In the situation described above, the another vehicle m transmits a request signal to the host vehicle M. The request signal is, for example, a signal including information inquiring the host vehicle M of an affirmation or denial for a lane change like “May I change (join) a lane?” In addition, the another vehicle m transmits an ID (identification information) of the host vehicle M, information indicating a position of the another vehicle m, and information indicating the speed together with the request signal to the host vehicle M.

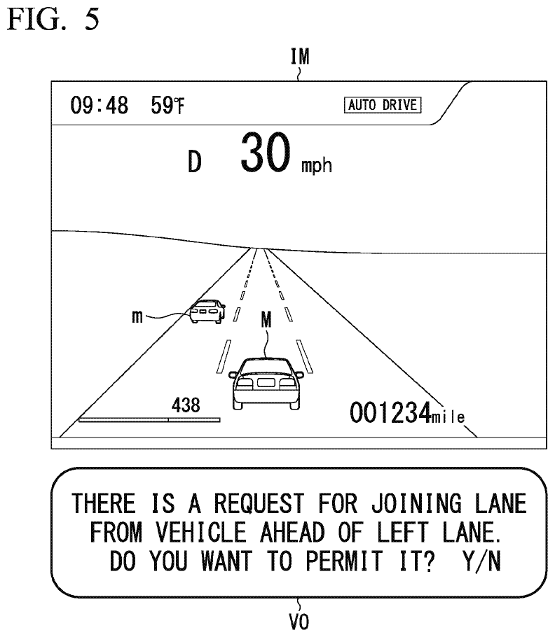

If the host vehicle M receives the request signal, the information processor 124 recognizes a position of the another vehicle m on the basis of the information transmitted by the another vehicle m and the position of the another vehicle m recognized by the external environment recognizer 121, and identifies the another vehicle m. Then, the inquirer 125 causes the speaker 34 to output information inquiring of the affirmation or denial for whether to allow the another vehicle m to interrupt. The inquiring information is, for example, information such as “There is a request for a lane change from another vehicle m ahead of a left lane (the lane L1). Do you want to permit it?” Note that, at this time, the information processor 124 causes the display 32 to display an image indicating information on the periphery of the host vehicle M. In addition, the information processor 124 may emphasize the another vehicle m that has transmitted the request signal as compared to other vehicles in an image. FIG. 5 is a diagram which shows an example of an image IM displayed on the display 32 and a voice VO output from the speaker 34 when a request signal is received.

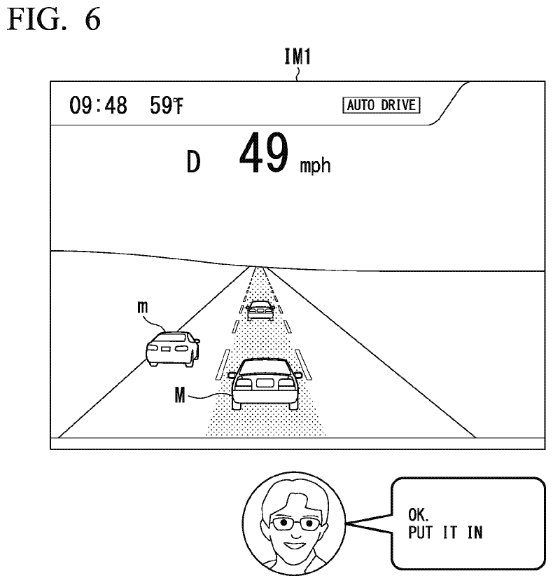

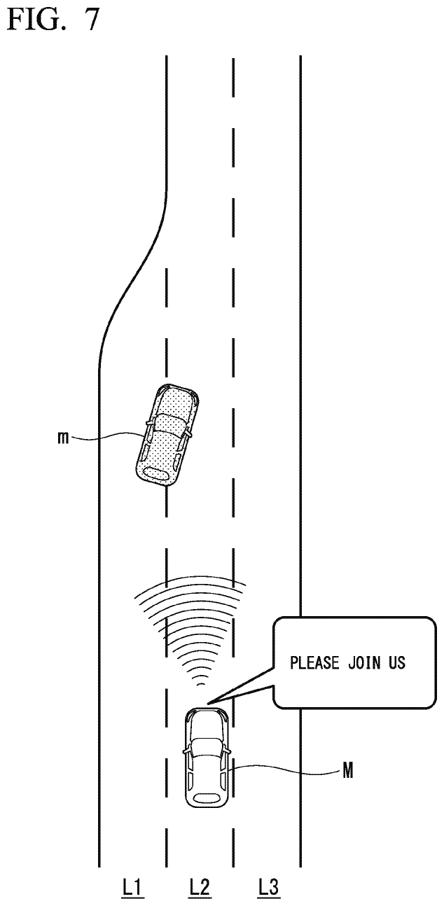

With regard to the information inquiring of the affirmation or denial, when the occupant of the host vehicle M has permitted a lane change as shown in FIG. 6, for example, the host vehicle M slows down the speed and transmits, as shown in FIG. 7, information indicating it has permitted the another vehicle m to change a lane, and the like to the another vehicle m. FIG. 6 is a diagram which shows an example of a scene in which the occupant of the host vehicle M has permitted a lane change. For example, when the occupant of the host vehicle M has spoken, for example, “Okay, let it in” to the microphone 36 for the inquiry of an affirmation or denial, the voice processor 150 determines whether the occupant of the host vehicle M has agreed to the inquiry, and outputs a result of the determination to the information processor 124. The information processor 124 permits a lane change of the another vehicle m when the occupant agrees with the lane change of the another vehicle m. In addition, when the lane change of the another vehicle m is permitted and the speed of the host vehicle M is slowed down, an image IM1 indicating a behavior of the host vehicle M and the surrounding situation of the host vehicle M is displayed on the display 32.

FIG. 7 is a diagram which shows an example of a scene in which the host vehicle M transmits information indicating that it permits a lane change to the another vehicle m and the another vehicle m changes a lane to the lane L2. The information processor 124 transmits information indicating that a lane change is permitted, an ID of the host vehicle M, positional information of the host vehicle M, and information indicating the speed of the host vehicle M to the another vehicle m. If the another vehicle m receives the information indicating that a lane change is permitted, the ID of the host vehicle M, the positional information of the host vehicle M, and the information indicating the speed of the host vehicle M, it identifies the host vehicle M that has permitted a lane change and changes a lane in front of the host vehicle M in the lane L2.

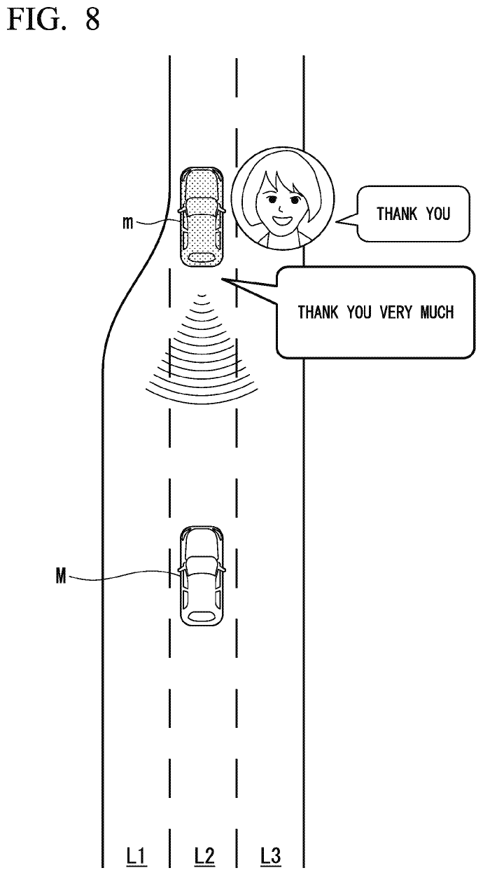

When the another vehicle m has changed a lane to the lane L2, if an occupant of the another vehicle m has input a speech indicating gratitude (for example, “Thank you” or the like) to the microphone 36, the another vehicle m transmits information indicating gratitude to the host vehicle M. FIG. 8 is a diagram which shows an example of a scene in which the another vehicle m has transmitted information indicating gratitude to the host vehicle M.

If the host vehicle M receives the information indicating gratitude from the another vehicle m, the information processor 124 causes the speaker 34 to output voice indicating gratitude from the another vehicle m on the basis of the received information. In addition, when the information processor 124 has received the information indicating gratitude from the another vehicle m, it causes the speaker 34 to output information indicating that an evaluation for an excellent driver (excellent driver evaluation) has risen.

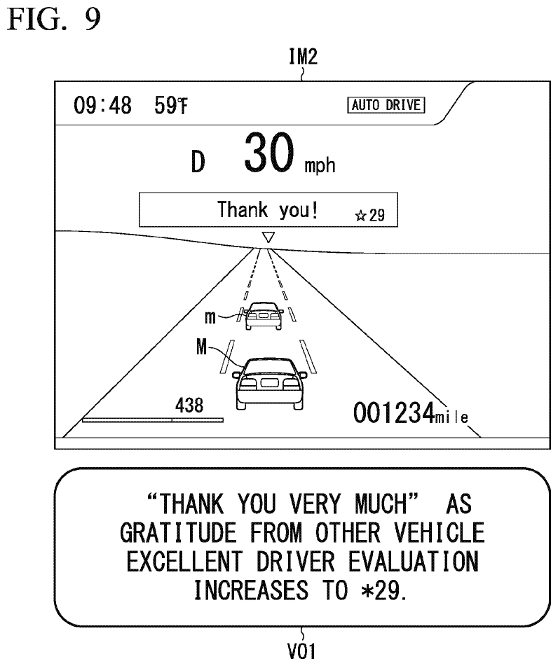

The excellent driver evaluation is an evaluation that rises according to the number of times gratitude is received from another vehicle m. Information on the excellent driver evaluation is stored in the storage 160. FIG. 9 is a diagram which shows an example of a voice VO1 output by the speaker 34 after the another vehicle m has changed a lane to the lane L2 and an image IM2 displayed on the display 32. Note that the excellent driver evaluation is represented by the number of stars in the image IM2.

[Flowchart]

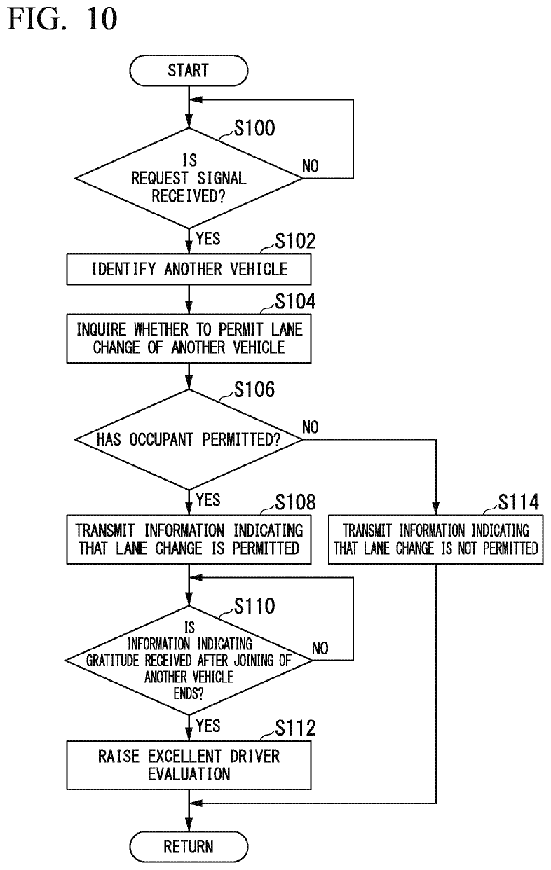

FIG. 10 is a flowchart which shows an example of a flow of processing executed by the information processor 124. First, the information processor 124 determines whether a request signal has been received from another vehicle m (step S100). If the request signal has been received from the another vehicle m, the information processor 124 identifies the another vehicle m that has transmitted the request signal on the basis of information transmitted by the another vehicle m (step S102). Next, the inquirer 125 inquires of the occupant as to whether to permit a lane change of the another vehicle m (step S104). Then, the information processor 124 determines whether the occupant has permitted the lane change (step S106).

When the occupant has permitted the lane change, the information processor 124 transmits information indicating that the lane change is permitted to the another vehicle m (step S108). At this time, the host vehicle M may decelerate. If the another vehicle m receives the information indicating that the lane change is permitted from the host vehicle M, the another vehicle m changes a lane to a lane in which the host vehicle M travels.

Next, the information processor 124 determines whether information indicating gratitude has been received after the lane change of the another vehicle m ends on the basis of a result of the recognition performed by the external environment recognizer 121 (step S110). When the lane change of the another vehicle m is determined to have ended and the information indicating gratitude has been received, the information processor 124 causes the excellent driver evaluation for the occupant of the host vehicle M to rise (step S112).

When the occupant has not permitted the lane change, the information processor 124 transmits information indicating that the lane change has not been permitted to the another vehicle m (step S114). Transmission of the information indicating that the lane change has not been permitted to the another vehicle m is an example of “control not allowing the another vehicle m to interrupt.” In addition, at this time, the host vehicle M may accelerate or maintain a current speed. As a result, processing of one routine of the present flowchart ends.

According to the processing described above, it is possible to determine whether the occupant of the host vehicle M agrees with a request for a lane change transmitted from the another vehicle m. As a result, control in which the intention of the occupant is reflected is performed, and thereby reliability with respect to control of a vehicle can be improved.

Note that the inquirer 125 may determine whether to make an inquiry to the occupant of the host vehicle M with the on-board equipment in accordance with the type of event. For example, the inquirer 125 does not make an inquiry to the occupant when a first type of event among events has occurred. In this case, a controller of the on-board equipment executes control of the on-board equipment associated with an action for the first type of event. On the other hand, the inquirer 125 makes an inquiry to the occupant when a second type of event other than the first type of event among the events has occurred. In this case, the controller of the on-board equipment executes control of the on-board equipment associated with an action for the second type of event in accordance with the information indicating an affirmation or denial of the occupant acquired by the information processor 124. For example, the inquirer 125 does not make an inquiry to the occupant when an event in which an email is received has occurred in the HMI 30. In this case, a controller that controls the HMI 30 causes the speaker to output details of the received email using voice. For example, the inquirer 125 makes an inquiry to the occupant when an event in which a video phone is received has occurred in the HMI 30. In this case, the controller that controls the HMI 30 connects a partner of the video phone and the HMI 30 when an incoming phone is permitted by the occupant.

In addition, the first type of event or the second type of event may be an event arbitrarily determined in advance. For example, the first type of event is an event that has been planned in advance or an event that has been planned in advance by the action plan generator 123. For example, the second type of event is an event different from the event that has been planned in advance and is an event that occurs unexpectedly (however, except for an event required for the host vehicle M to smoothly travel among events occurring unexpectedly). For example, the first type of event is a lane change event or a branching event that has been determined in advance. For example, the second type of event may be an event that receives the request signal described above, an event related to a video phone, or the like.

As described above, since it is determined whether to make an inquiry of the occupant of the host vehicle M with the on-board equipment in accordance with the type of an event, the convenience for a user can be further improved.

### Modified Example 1

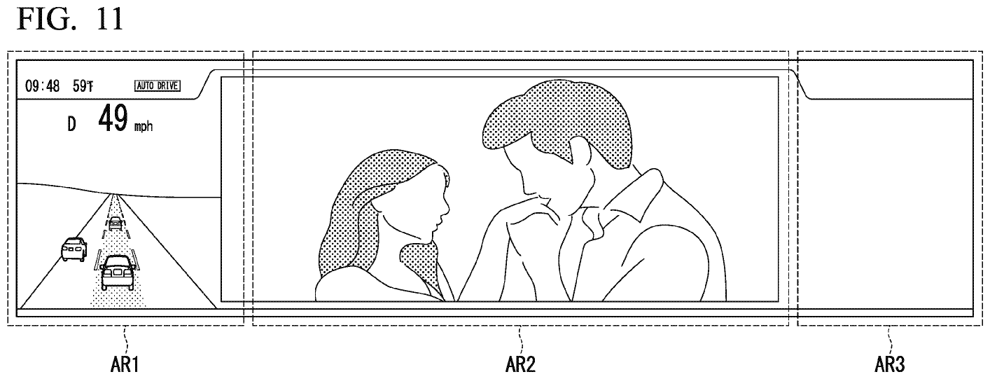

The display 32 may display not only an image indicating the behavior of the host vehicle M and the periphery of the host vehicle M but also other images. FIG. 11 is a diagram which shows an example of an image displayed on the display 32 of a modified example 1. As shown in FIG. 11, different images may be displayed on the display 32 in areas AR1 to AR3. For example, an image IM11 indicating the behavior of the host vehicle M, and the periphery of the host vehicle M which has been recognized by the external environment recognizer 121 is displayed in an area AR1. For example, an image IM12 selected by a user is displayed in an area AR2. The image IM12 selected by a user is, for example, information such as an image having entertainment properties, a moving image (for example, a movie), map information, or a tourist spot of destination. In addition, for example, an image IM13 including information transmitted from the another vehicle m (text information associated with the request signal, text information indicating gratitude, or the like), text information spoken by the occupant of the host vehicle M, and the like is displayed in an area AR3.

Note that a part of the images IM11 to IM13 may be omitted according to a state of the host vehicle M or an operation of the occupant. For example, the image IM12 may be displayed on the display 32 in the areas AR1 to AR3 before the request signal is received from the another vehicle m, and the images IM11 to IM13 may be displayed on the display 32 as shown in FIG. 11 after the request signal from the another vehicle m is received.

As described above, since the image displayed on the display 32 changes in accordance with the state of the host vehicle M, the convenience for a user can be improved.

### Modified Example 2

The information processor 124 may cause the storage 160 to store a history of affirmations or denials of the occupant for an inquiry from another vehicle m, refer to the affirmation or denial information stored in the storage 160, and make an inquiry to the occupant for affirmation or denial for a lane change such that a majority of answers between affirmation and denial are answers indicating agreement.

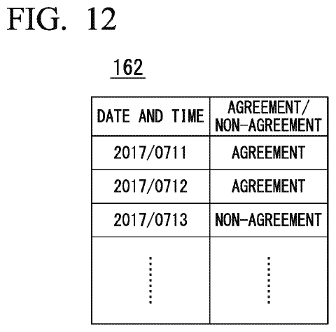

FIG. 12 is a diagram which shows an example of the affirmation or denial information 162. The affirmation or denial information is information in which information indicating a response (an agreement or a non-agreement) to a request signal is associated with a date and time at which the request signal is received. For example, the information processor 124 makes an inquiry such that more answers between the affirmation and denial for a lane change are answers indicating an agreement in the affirmation or denial information 162. For example, the information processor 124 makes an inquiry such as “May I permit a lane change?” when a rate of agreement with the lane change is higher than a rate of non-agreement, and makes an inquiry such as “May I not permit a lane change?” when the rate of agreement with the lane change is lower than the rate of non-agreement.

As described above, since the information processor 124 has made an inquiry that is easy for a user to answer on the basis of the information stored in the affirmation or denial information 162, convenience for the user can be further improved.

According to the first embodiment described above, the automated driving controller 100 acquires information indicating the affirmation or denial of the occupant for an inquiry to the occupant of the host vehicle M for determining whether to execute control associated with an action by controlling the HMI 30 and an inquiry input to the HMI 30, and executes control of the on-board equipment of the host vehicle M associated with the action in accordance with the acquired information indicating the affirmation or denial of the occupant, thereby performing control of the on-board equipment in which the intention of the occupant is reflected.

### Second Embodiment

A second embodiment will be described. The second embodiment further includes a learner that performs learning by linking geographic factors or environmental factors to the affirmation or denial of the occupant associated with an action. Hereinafter, differences from the first embodiment will be mainly described.

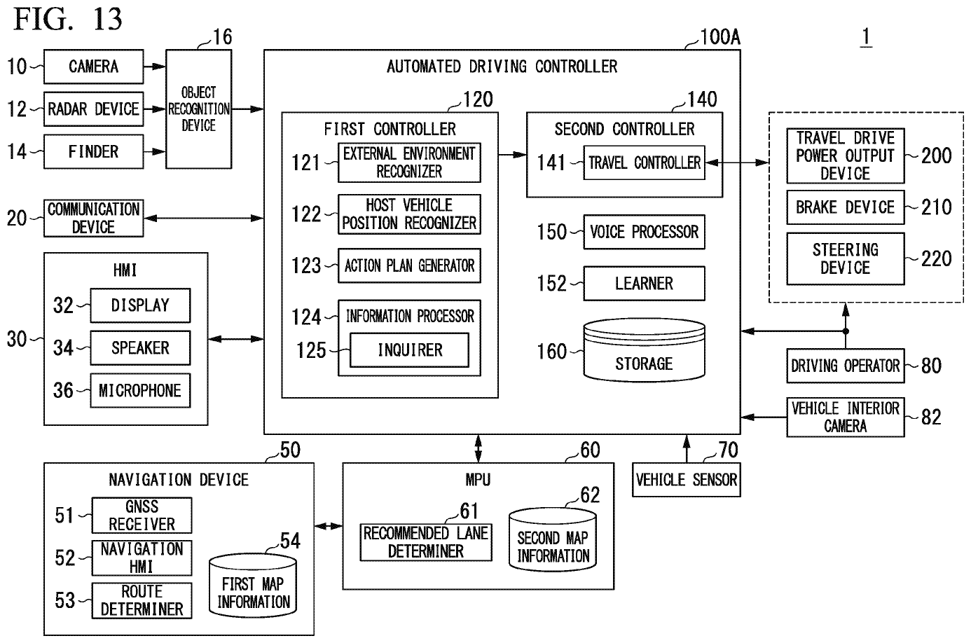

FIG. 13 is a configuration diagram of the vehicle system 1 including an automated driving controller 100A of the second embodiment. The automated driving controller 100A further includes a learner 152 in addition to functional constituents of the automated driving controller 100 of the first embodiment.

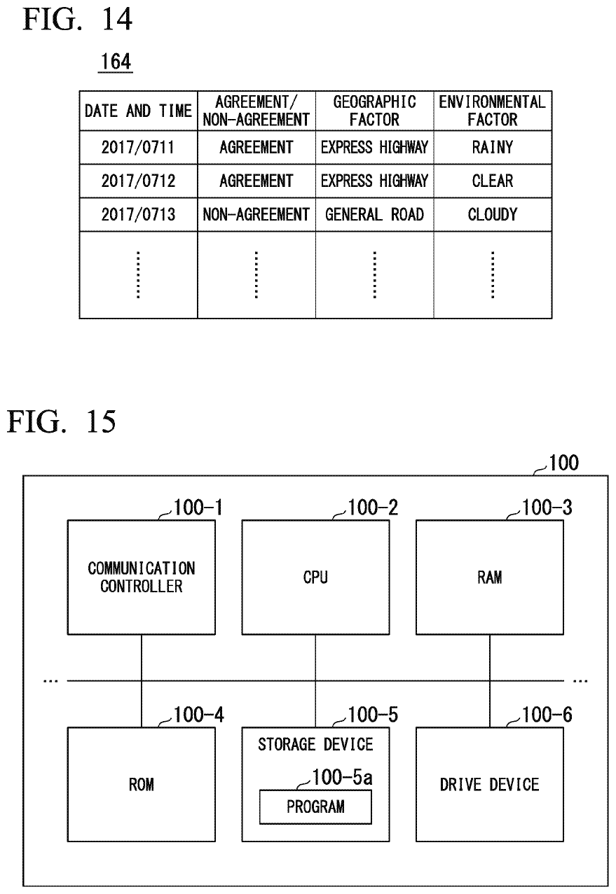

The learner 152 performs, for example, machine learning on the target information 164. FIG. 14 is a diagram which shows an example of the target information 164. The target information 164 is, for example, information in which details of a response to an inquiry from another vehicle m, a response date and time, geographic factors, and environmental factors are associated with one another.

The geographic factors are a type of a road on which the host vehicle M travels (a general road or an express highway), a position on the road (a lane, or the like), whether the road is a road over which the host vehicle M (driver) passes frequently or whether the road is a road which is unfamiliar to the host vehicle M, and the like. The information processor 124 acquires the geographic factors in which the host vehicle M travels from the information stored in the storage device of the host vehicle M or the information acquired by the navigation device 50.

The environmental factors include the weather, a time, day or night, the day of the week, a season, a temperature, a road congestion state, a travel speed, a state of a driver, and the like. The state of a driver is a fatigue level, a stress level, or the like of the driver. The information processor 124 acquires the environmental factors from the information stored in the storage device of the host vehicle M, and information provided by sensors provided in the host vehicle M, the server device providing information. The state of a driver is estimated on the basis of, for example, information obtained by sensors provided on steered wheels, sensors mounted on the driver, and the like. The learner 152 performs learning by linking the geographic factors or environmental factors to the affirmation or denial of the occupant associated with an action. As a result, it is learned under which geographic factors or environmental factors the occupant tends to permit a lane change.

The information processor 124 makes an inquiry to the occupant to have a response indicating that the occupant agrees with a lane change under geographic factors or environmental factors in which the host vehicle M is traveling on the basis of the geographic factors or the environmental factors in which the host vehicle M is traveling and a result of the learning performed by the learner 152.

Note that the learner 152 may perform learning by linking situations in a compartment of the host vehicle M in addition to (or instead of) the geographic factors and environmental factors to the affirmation or denial of the occupant associated with an action. In this case, the target information 164 stores the situations in the compartment of the host vehicle M with respect to information indicating agreement or non-agreement. The situations in the compartment include a presence or absence of a passenger, a type of an image displayed on the display 32 (map information, movie, or the like), and the like.

In the second embodiment described above, the learner that performs learning by linking the geographic factors or environmental factors to the affirmation or denial of the occupant associated with an action is further included, and thereby it is possible to make an inquiry to the occupant to have a response indicating that the occupant agrees with a lane change.

[Others]

Note that, in the example described above, an example in which the request signal is transmitted when the another vehicle m changes (joins) a lane has been described. Instead of (or in addition to) this, when a request signal that requests for a lane change is transmitted to the host vehicle M, an inquiry may be made to the occupant of the host vehicle M as to whether the host vehicle M changes a lane. A request for lane change to the host vehicle M is that a vehicle traveling behind the host vehicle M makes a request to the host vehicle M to change a lane in a lane in which the host vehicle M travels on a road with a plurality of lanes whose travel directions are the same. That is, a following vehicle requests the host vehicle M to change a lane and give way.

In addition, when a predetermined event has occurred regardless of the request signal being transmitted from the another vehicle m, the automated driving controller 100 (100A) may inquire of the occupant as to whether to execute a predetermined action, and execute the action when a response to the inquiry indicating to execute is obtained.

The predetermined event is, for example, an event (for example, an example of the second type of event) occurring when there is another vehicle m traveling at a legal speed or lower ahead. In this case, the predetermined action is an action that overtakes the another vehicle m ahead. For example, the information processor 124 inquires of the occupant as to whether to overtake the another vehicle m ahead, and causes the automated driving controller 100 (100A) to execute control to overtake the another vehicle m ahead when a response indicating to overtake is obtained.

In addition, the predetermined event is not limited to a situation outside the host vehicle M, and may be an event occurring on the basis of a situation of the host vehicle M. For example, the occurring event is an event (an example of the second type of event) that reproduces a predetermined music and causes the speaker to output it on the basis of the position of the host vehicle M. The predetermined action at this time is, for example, an action that reproduces the predetermined music and causes the speaker to output it. For example, on the basis of a travel position of the host vehicle M, the information processor 124 inquires whether to reproduce a recommended song and to cause the speaker 34 to output the song when the host vehicle M travels at that position, and instructs a device controller such that it reproduces the recommended song and causes the speaker to output it when a response indicating output to be caused is obtained. In this case, the device controller is a controller that is mounted on the host vehicle M and controls a predetermined device such that it causes a speaker to output the recommended song. The device controller is an example of “controller.”

The device controller refers to correspondence information in which positional information stored in the storage device mounted on the host vehicle M and recommended songs are associated with each other, and selects a recommended song. For example, a song with a theme of the sea is associated with positional information associated with a road along the sea.

In addition, the inquirer 125 may inquire whether to reproduce a recommended song associated with the travel state of the host vehicle M instead of the travel position of the host vehicle M. For example, in this case, a song that relieves stress is associated with a travel state in which the host vehicle M is involved in a traffic jam and slowing down and stopping are repeated in the correspondence information.

Moreover, the occurring event may be an event occurring on the basis of not only the situation outside the host vehicle M but also a situation inside the host vehicle M. In this case, the occurring event is an event (an example of the second type of event) that changes an operation state of an air conditioner of the host vehicle M on the basis of the situation inside the host vehicle M. The predetermined action at that time is an action that increases (or decreases) an output degree of the air conditioner of the host vehicle M. For example, the information processor 124 inquires of the occupant as to whether to adjust cooling to lower a temperature in the compartment when the temperature in the compartment is equal to or higher than a predetermined temperature in summer, and instructs an air conditioner controller to adjust the cooling when a response indicating to adjust the cooling is obtained. The air conditioner controller is a controller that is mounted on the host vehicle M and controls the air conditioner. The air conditioner controller is an example of the “controller.”

In addition, the occurring event may be an event (for example, an example of the second type of event) in which the navigation device 50 changes a route to the destination. In this case, the predetermined action is an action in which the navigation device 50 searches for a route to the destination again and sets it. For example, the information processor 124 inquires of the occupant as to whether to search for the route again, and instructs a controller of the navigation device 50 to search for the route again when a response indicating to search is obtained. The controller that controls the navigation device 50 is an example of the “controller.”

In addition, in the embodiment described above, it is described that an inquiry or response is made by voice, but the present invention is not limited thereto. For example, a response may be made by causing the display 32 to display an inquiry image and the occupant performing an input operation to the display 32. Moreover, the response may be a predetermined gesture. For example, the occupant performs a predetermined gesture on the vehicle interior camera 90. The automated driving controller 100 may analyze an image captured by the vehicle interior camera 90 and determine whether the occupant has performed a predetermined gesture on the basis of a result of the analysis.

According to the embodiments described above, it is possible to control the on-board equipment in which the intention of the occupant is reflected by including the HMI 30 that receives an input of information performed by the occupant of a vehicle, the information processor 124 that inquires of the occupant of the host vehicle M as to whether to execute an action by controlling an interface, and acquires information indicating the affirmation or denial of the occupant for an inquiry input to the interface when an action related to the behavior change of the vehicle for an event occurring while the host vehicle M is traveling, and the controller 120 that executes control of the on-board equipment of the host vehicle M associated with an action in accordance with information indicating the affirmation or denial of the occupant acquired by the information processor 124.

[Hardware Configuration]

The automated driving controllers 100 and 100A of the embodiments described above are realized by a hardware configuration as shown in FIG. 15. FIG. 15 is a diagram which shows an example of a hardware configuration of the automated driving controllers 100 and 100A of the embodiments.

The automated driving controllers 100 and 100A are configured to include a communication controller 100-1, a CPU 100-2, a RAM 100-3, a ROM 100-4, a secondary storage device 100-5 such as a flash memory or an HDD, and a drive device 100-6 connected to one another by an internal bus or a dedicated communication line. The drive device 100-6 is embedded with a portable storage medium such as an optical disc. A program 100-5a stored in the secondary storage device 100-5 is expanded in the RAM 100-3 by a DMA controller (not shown) or the like and executed by the CPU 100-2, and thereby the first controller 120 and the voice processor 150 are realized. In addition, a program referred to by the CPU 100-2 may be stored in the portable storage medium mounted to the drive device 100-6, and may be downloaded from another device via a network NW.

The embodiments described above can be expressed as follows.

A storage device and a hardware processor are included, and a program is stored in the storage device which causes the hardware processor to inquire of, when a vehicle selects an action related to a behavior change of the vehicle for an event occurring while the vehicle travels, an occupant of the vehicle as to whether to execute the action by controlling an interface that outputs information and receives an input of information performed by the occupant of the vehicle, to acquire information indicating the affirmation or denial by the occupant of the inquiry input to the interface, and to execute control of an on-board equipment of the vehicle associated with the action in accordance with the acquired information indicating the affirmation or denial of the occupant.

As described above, the modes for implementing the present invention have been described using the embodiments, but the present invention is not limited to the embodiments at all, and various modifications and substitutions can be made within a range not departing the gist of the present invention.

### REFERENCE SIGNS LIST

1 Vehicle system
32 Display
34 Speaker after a lane change
36 Microphone
100, 100A Automated driving controller
120 First controller
124 Information processor
125 Inquirer
150 Voice processor
152 Learner
160 Storage
162 Affirmation or denial information
164 Target information
M Host vehicle
m Another vehicle

What is claim is:

1. A vehicle control system, comprising:
an interface configured to receive an input of information from an occupant of a vehicle;
an inquirer configured to, when the vehicle selects an action related to a behavior change of the vehicle in response to an event occurring while the vehicle is traveling, control the interface and to inquire of the occupant of the vehicle as to whether to execute the action;
an information processor configured to acquire information indicating the affirmation or denial by the occupant of the inquiry, which has been input to the interface; and
a controller configured to execute control of on-board equipment in the vehicle, which associated with the action, in accordance with the information indicating affirmation or denial of the occupant, which is acquired by the information processor.

2. The vehicle control system according to claim 1,
wherein the controller executes the control of the on-board equipment associated with the action without making the inquiry to the occupant using the inquirer when a first type of event occurs in the event, and executes the control of the on-board equipment associated with the action in accordance with the information indicating the affirmation or denial of the occupant, which is acquired by the information processor when a second type of event other than the first type of event occurs.

3. The vehicle control system according to claim 1 or 2,
wherein the event occurs on the basis of a situation outside the vehicle.

4. The vehicle control system according to claim 1,
wherein the action includes at least one of controlling steering of the vehicle and controlling acceleration or deceleration.

5. The vehicle control system according to claim 1,
wherein the action is an operation of causing another vehicle to interrupt in front of the vehicle.

6. The vehicle control system according to claim 1,
wherein the event includes receiving a request signal for interruption from another vehicle, and
the action when the request signal is received is an operation of causing the another vehicle to interrupt in front of the vehicle.

7. The vehicle control system according to claim 5,
wherein, when the information processor acquires information indicating agreement with the interruption, the controller controls the vehicle such that the vehicle allows the another vehicle to interrupt and, when the information processor acquires information indicating non-agreement with the interruption, the controller controls the vehicle such that the vehicle does not allow the another vehicle to interrupt.

8. The vehicle control system according to claim 1, further comprising:
a storage configured to store a history of the affirmation or denial of the occupant associated with the action,
wherein the inquirer makes the inquiry to the occupant on the basis of the history stored in the storage such that an answer with a larger frequency between the affirmation and denial is an answer indicating agreement.

9. The vehicle control system according to claim 1, further comprising:
a learner configured to perform learning by linking geographic factors or environmental factors to the affirmation or denial of the occupant associated with the action,
wherein the inquirer makes the inquiry to the occupant such that the occupant is more likely to give an answer of agreement on the basis of the geographic factors or the environmental factors and a result of learning performed by the learner when the inquiry is made to the occupant.

10. A vehicle control method, comprising:
by a computer,
inquiring of, when a vehicle selects an action related to a behavior change of the vehicle in response to an event occurring while the vehicle is traveling, an occupant of the vehicle as to whether to execute the action by controlling an interface that receives an input of information from the occupant of the vehicle;
acquiring information indicating affirmation or denial by the occupant of the inquiry input to the interface; and
executing control of on-board equipment of the vehicle, which associated with the action, in accordance with the acquired information indicating the affirmation or denial of the occupant.

11. A non-transitory computer-readable storage medium that stores a computer program to be executed by a computer to at least:
inquire of, when a vehicle selects an action related to a behavior change of the vehicle in response to an event occurring while the vehicle travels, an occupant of the vehicle as to whether to execute the action by controlling an interface that receives an input of information from the occupant of the vehicle;
acquire information indicating affirmation or denial by the occupant of the inquiry input to the interface; and
execute control of on-board equipment of the vehicle, which associated with the action, in accordance with the acquired information indicating the affirmation or denial of the occupant.
